(19) United States
(12) Patent Application Publication
(10) Pub. No.: US 2015/0127633 A1
(43) Pub. Date: May 7, 2015

(54) CONTENT ROTATING SOFTWARE

(71) Applicants: Hartin Jeff, Carnation, WA (US); Scott Wilkerson, Kirkland, WA (US); Ron O'Ferrall, Kirkland, WA (US)

(72) Inventors: Hartin Jeff, Carnation, WA (US); Scott Wilkerson, Kirkland, WA (US); Ron O'Ferrall, Kirkland, WA (US)

(21) Appl. No.: 14/072,508

(22) Filed: Nov. 5, 2013

(51) Int. Cl. G06F 17/30; H04L 12/58

(52) U.S. Cl. CPC G06F 17/30864; G06F 17/30424; H04L 51/046
USPC 707/722; 707/769

(57) ABSTRACT

A content rotating software system and method are described. In one disclosed embodiment, a system includes a program to receive a text message originated request, access and query a database in response to the request, and generate a rotating page of results and an address to the page to send to the device that sent the request.

### BACKGROUND

1. Field of the Invention

The invention relates to content rotating software. More specifically the invention relates to displaying rotating search results based on user interests and location and may be implemented to provide a mobile web based response to a text message input.

2. Prior Art

Current electronic advertising models include displaying advertising content in the same distribution channel as user requested information. Additionally, the current advertising models are often predicated on pay-per-click (PPC) and pay-per-mille (PPM) models for advertisers and/or complex search engine optimization (SEO) and search engine marketing (SEM) initiatives. Unfortunately, these approaches can be limiting to advertisers and consumers and can be relatively costly for small business entities.

### SUMMARY

Accordingly, an improved method and apparatus for rotating content based on a user query is described below in the Detailed Description. For example, one disclosed embodiment provides a system including a program to receive a text message originated request, access and query a database in response to the request, and generate a rotating page of results and an address to the page to send to the device that sent the request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a first embodiment of a content rotating software system.

FIG. 2 shows an example of a second embodiment of a content rotating software system.

FIG. 3 shows a process flow depicting an embodiment method for content rotating software.

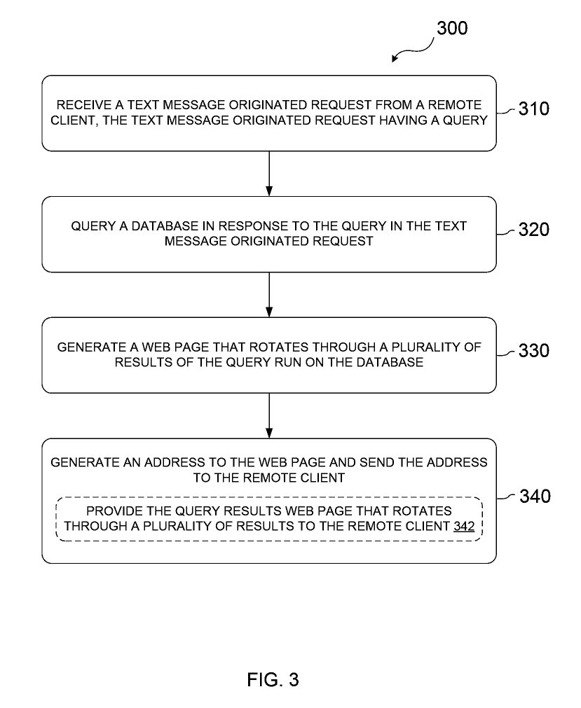

### DETAILED DESCRIPTION

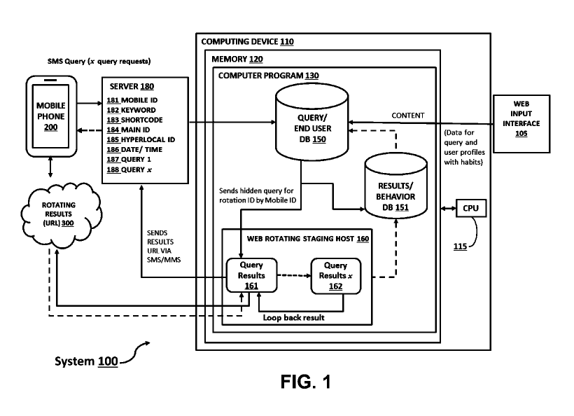

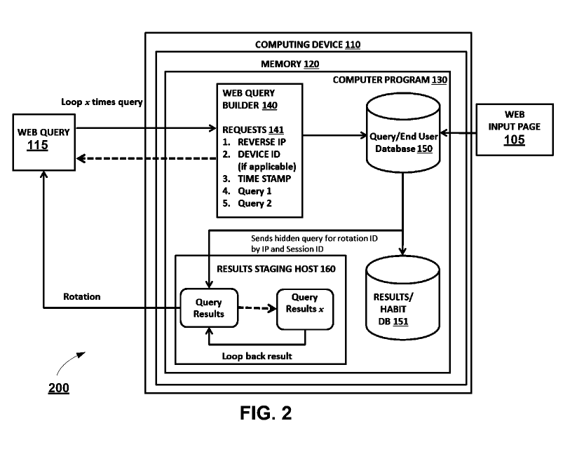

Embodiments herein describe a system for displaying content to a user using a content rotating system. Other embodiments describe a text message based input and web based output system. These systems may be used in conjunction in the manner depicted in FIG. 1 and FIG. 2, but other embodiments are not so limited. The following paragraphs describe the embodiment illustrated in FIG. 1.

FIG. 1 shows an example embodiment system 100 that includes a computing device 110, a web input interface 105, a server 180, a mobile phone 200 and rotating results 300. Computing device 110 includes a processor 115, a memory 120, at least one computer program 130 a query database 150, a results database 151 and a web rotator staging host 160 with query results call back 161 and query results call back 162. In this embodiment, a mobile phone 200 may send one or more text message query requests to a server 180, for example using SMS, MMS or other suitable messaging protocols. Upon a query trigger, server 180 sends query bundle parameters to a query/user database 150 that is accessed by a computer program 130 operating in memory in computing device 110. The server may either forward the text message query request or may convert the request to another format and send it as another query request that was originally a text message request. In either case, the query request may be a text message originated request, however embodiments are not so limited and may use other suitable formats. In the illustrated embodiment, server 180 is a separate device from computing device 110; however other embodiments are not so limited. For example, server 180 may share hardware and/or software with computing device 110, may be the same device as computing device 110, may share a processor with computing device 110, etc.

In the illustrated embodiment, rotator staging host 160 may receive a hidden query request for a rotation ID by mobile ID from database 150 which may simultaneously transmit the unique combination of user query requests and results to a results database 151. This allows future queries to receive progressively refined query results based on the matched content availability of database 150 and the historical data of database 151. In some embodiments, query result content may be uploaded via a web input interface 105 to the query results database 150. In one example, web input interface 105 may include results from a search conducted on an external search engine.

In one example, mobile phone 200 may send an SMS keyword 182 query to a server 180 hosted shortcode 183. The server 180 may then populate one or more categories of a query bundle for mobile phone 200. For example, a query bundle may contain one or more of a mobile ID 181 for mobile phone 200, a keyword 182, a shortcode 183, a main ID 184, a hyperlocal ID 185, a date/time 186, a first query 187, or subsequent queries 188. In the present embodiment, a mobile ID 181 is generated based on the mobile phone number for a session. In this embodiment, the main ID 184 is generated from the mobile number and session date/time stamp 186 and hyperlocal ID 185 are generated by the shortcode 183, however other embodiments may generate a main ID 184, a date/time stamp 186 and a hyperlocal ID 185 from other suitable information.

Upon generation of a query bundle, server 180 transmits the query bundle to query database 150 and computer program 130 matches available content in the query database 150 to query 186, query 188, etc. The query database 150 may send the query bundle with matching content to results database 151 and to rotator staging host 160 where query results and associated content may be prioritized into a unique uniform resource locator (“URL”) with pre-loaded priority parameters. In one example, query results and associated content may be prioritized into unique URL's with pre-loaded priority parameters using a web input interface 105. Rotator staging host 160 then may send packaged query parameters and a designated URL with instructions for the server 180 to deliver the query results that match the mobile ID 181 as an SMS or MMS message to the mobile phone 200. In other embodiments rotator staging host 160 may send packaged query parameters and a designated URL to mobile phone 200.

In some embodiments, after the rotating results URL 300 is activated, a reverse IP search can be used to identify the approximate geographic location of mobile phone 200. If location services are activated on mobile phone 200, location information may be determined also be determined or queried without using a reverse IP search.

Query results 161 are presented through a mobile website of the activated URL. The rotator staging host 160 presents the results to the mobile phone 200 and automatically advances to the next query results 162 after (x time). In some embodiments, the rotator staging host 160 can advance to a next set of query results after preset durations, after user set durations, over multiple durations, after user selections, based on historical data by the user, etc. In some embodiments, the mobile phone 200 user can manually advance to the next query result 162 prior to the duration the rotator staging host 160 would have used to rotate to the next query results.

In some embodiments, the rotator staging host 160 can provide mobile phone 200 query interactions and inputs to the results database 151 for future queries on the query user database 150. This provides a more efficient and targeted system experience for a user by matching progressive behavioral interests with more relevant search queries.

An example use case scenario will now be described with reference to FIG. 1. A mobile phone user in Portland, Oreg. who is looking for a home may input a query by texting the word “HOME” to the shortcode number 503-411. In this example, the shortcode is generated with the area code as the first three numbers and the information code as the following numbers in the shortcode. Other shortcodes may be used in similar fashion. The shortcode would then be included in the query bundle along with their query 187.

In response, the user may receive a message with an additional query, stating “Welcome to Portland Home Finder. What is the price range? (a) $50 k-150 k; (b) $151 k-250 k; (c) $251 k-350 k (d) ALL.” As an example, if the user responds with (a) as their selection, they then may receive another response message stating “Please reply with the zip code of your targeted neighborhood, or if you are there now, tap this link: http://wb.ro/home”. In response, a user may respond with by texting their zip code or tapping a link in the response message and the server 180 or the computing device 110 can geolocate the user and/or derive their zip code, if needed.

In this example, the server 180 or computer program 130 may then respond with another request message stating, “Would you like a local Realtor™ to contact you? Y or N?” If in response to this, the user texts “Y”, then a concluding message can be sent stating, “Thank you, a Realtor™ will get with you shortly. Here are your hyperlocal results! http://wb.ro/phome42”. In this example, the server 180 or computing device would receive a query profile, and could record responses from the user, determine their location, and store their Mac address, mobile number, time stamp. In response to the query and the user's location, web rotating staging host 160 can then generate a page showing the results of the query or interaction and send a URL that points to a web page displaying the results. If there are multiple results that fit the user's query then the web rotating staging host 160 can serve a page that rotates through the results at set durations, user defined durations, user selected advances, user adjustable durations, etc.

FIG. 2 shows an example embodiment system 200 with a computing device 110 to provide content rotation in response to a web query 115. Computing device 110 includes a web query builder 140 having a request 141 with similar functionality to the query bundle of system 100. The request 141 may contain location information retrieved from a reverse IP lookup, and may also contain a device ID for the originating web query 115, a time stamp for the time of the query, and one or more queries. Computing device 110 also includes a query/end user database 150, a results/habit database 151, a results staging host 160 which in turn includes one or more instances of query results, wherein results staging host 160 can provide a rotating page of query results in response to web query 115.

In this embodiment, a web query 115 may be received at computing device 110. Web query builder 140 may then generate one or more requests to forward to query/end user database 150. Upon generation of a request 141, computer program 130 matches available content in the query database 150 to the request 141. The query database 150 may send the request 141 with matching content to results database 151 and to results staging host 160 where query results and associated content may be prioritized into a URL with pre-loaded priority parameters. For example, query results and associated content may be prioritized into unique URL's with pre-loaded priority parameters using a web input interface 105. Results staging host 160 then may send packaged query parameters and a designated URL to the device that originated the web query 115.

In the illustrated embodiment, results staging host 160 may receive a hidden query request for a rotation ID by device ID from database 150 which may simultaneously transmit the unique combination of user query requests and results to a results database 151. This allows future queries to receive progressively refined query results based on the matched content availability of database 150 and the historical data of database 151. In some embodiments, query result content may be uploaded via a web input interface 105 to the query results database 150. In one example, web input interface 105 may include results from a search conducted on an external search engine.

In some embodiments, after the rotating results URL 300 is activated, a reverse IP search can be used to identify the approximate geographic location of the originating device. Query results may be presented through a mobile website of the activated URL. The results staging host 160 presents the results to the originating device and automatically advances to the next query results after (x time). In some embodiments, the results staging host 160 can advance to a next set of query results after preset durations, after user set durations, over multiple durations, etc. In some embodiments, the end-user can manually advance to the next query result prior to the duration the results staging host 160 would have used to rotate to the next query results.

It will further be understood that the configurations and/or approaches described herein are exemplary in nature, and that these specific embodiments or examples are not to be considered in a limiting sense, because numerous variations are possible. The specific methods described herein may represent one or more of any number of sequences involving the same limitations as claimed but in a different order.

The subject matter of the present disclosure includes all novel and nonobvious combinations and subcombinations of the various processes, systems and configurations, and other features, functions, acts, and/or properties disclosed herein, as well as any and all equivalents thereof.

1. A system comprising:
a program having access to a query database, the program to receive a text message originated request from a remote client and run a query on the query database based on the text message originated request;
a rotator staging host to generate a query results page containing results from the query database to the text message originated request, the web rotator staging host to further generate an address to the query results page, wherein the system is configured to send the address to the remote client and to serve the query results page to the remote client through a web browser on the remote client in response to a user selecting a link to the address.

2. The system of claim 1, wherein the rotator staging host rotates the query results page through a plurality of results that fit some at least some of the criteria of the text message originated request.

3. The system of claim 2, wherein the query results page is rotated through the results at predetermined intervals.

4. The system of claim 2, wherein the query results page is rotated through the results at user selected intervals.

5. The system of claim 1, wherein the text message originated request was one of an SMS and an MMS text message.

6. The system of claim 1, further comprising a results database to store the results of the text message originated query in accordance with a mobile identifier associated with the remote client.

7. The system of claim 6, wherein the results database can then be queried using the mobile identifier at a subsequent test message originated request.

8. The system of claim 1, wherein the address is a uniform resource locator.

9. A method comprising:
receiving a text message originated request from a remote client, the text message originated request having a query;
querying a database in response to the query in the text message originated request;
generating a query results web page that rotates through a plurality of results of the query run on the database;
generating a link having an address to the query results web page and sending the link to the remote client.

10. The method of claim 9, further comprising in response to the link being selected on the remote client, providing the query results web page that rotates through a plurality of results to the remote client.

11. The method of claim 10, wherein the query results web page is rotated through the results at predetermined intervals.

12. The method of claim 10, wherein the query results web page is rotated through the results at user selected intervals.

13. The method of claim 10, wherein the text message originated request was one of an SMS and an MMS text message.

14. The method of claim 10, further comprising storing the results of the text message originated query in a results database and associating the results with a mobile identifier associated with the remote client.

15. The method of claim 14, further comprising querying the results database using the mobile identifier in response to a subsequent test message originated request from the remote client.
